(19) United States
(12) Patent Application Publication
(10) Pub. No.: US 2025/0278880 A1
(43) Pub. Date: Sep. 4, 2025

(54) SYSTEM FOR ANIMATING A FIRST VIRTUAL ELEMENT WITHIN A VIRTUAL ENVIRONMENT, AND A METHOD THEREOF

(71) Applicant: Sony Interactive Entertainment Inc., Tokyo (JP)

(72) Inventors: Lawrence Green, London (GB); Philip Cockram, London (GB); Lewis Thresh, London (GB)

(73) Assignee: Sony Interactive Entertainment Inc., Tokyo (JP)

(21) Appl. No.: 19/046,753

(22) Filed: Feb. 6, 2025

(30) Foreign Application Priority Data
Feb. 29, 2024 (GB) 2402916.7

(51) Int. Cl. G06T 13/20; G06T 7/20; G06T 7/70; G06T 17/00

(52) U.S. Cl. CPC G06T 13/20; G06T 7/20; G06T 7/70; G06T 17/00

(57) ABSTRACT

A system for animating a first virtual element within a virtual environment, comprising: receiving circuitry configured to receive first state data descriptive of a state of the first virtual element, the first state data comprising one or more kinematic properties of the first virtual element; generating circuitry comprising a generating model trained to generate, based on the received first state data, animation data to be applied to the first virtual element; and animating circuitry configured to apply the generated animation data to the first virtual element.

### FIELD OF INVENTION

The present invention relates to a system for animating a first virtual element within a virtual environment, and a method thereof.

### BACKGROUND

Due to the desire to provide more realistic and immersive gameplay experiences, the computational complexity of video games has been increasing in recent years. One reason for this increase in computational complexity is the use of increasingly greater numbers of virtual elements (virtual objects/characters) within video game environments, which results in increasingly greater numbers of physical interactions (such as object collisions, projectile trajectories, fluid motion, and the like) to be modelled in order to facilitate gameplay.

However, this increase in computational complexity place a greater computational burden on the processors which are used to model these physical interactions, such processors having to perform a greater number of calculations and/or having to perform more complex calculations. This can lead to a number of issues.

For example, this increase in computational burden on the processor may cause the processors to operate at/close to their maximum limit in terms of throughput/bandwidth, which may negatively affect the gameplay experience for users. Examples of such negative effects include an increase in input lag between a user input to the video game and an action being taken by the user's in-game character in response to the user input, and a reduction in the frame rate at which the video game is being rendered. Moreover, knock-on effects such as a reduction in the resolution at which the video game is being rendered may occur due to the downstream rendering pipeline prioritising a more responsive gameplay experience (that is, reduced lag and/or higher frame rate) rather than a more immersive gameplay experience (that is, higher resolution and/or more detailed shading, texturing, lighting, and the like).

Alternatively or in addition, this increase in computational burden may cause the operating temperatures of such processors to increase, which could lead to the processor being irreparably damaged (or at least diminish/degrade the effectiveness of the processor in terms of efficiency/operating capabilities). Moreover, such a great number and/or high complexity of calculations may similarly affect other components of a system comprising the processor. For example, a memory may be utilised to a greater extent in order to perform these burdensome calculations, therefore increasing its operating temperature.

The present invention seeks to alleviate or mitigate these issues.

### SUMMARY OF THE INVENTION

In a first aspect, a system for animating a first virtual element within a virtual environment is provided in claim 1.

In another aspect, a method animating a first virtual element within a virtual environment is provided in claim 13.

Further respective aspects and features of the invention are defined in the appended claims.

Embodiments of the present invention will now be described by way of example with reference to the accompanying drawings, in which:

### BRIEF DESCRIPTION OF THE DRAWINGS

FIG. 1 schematically illustrates an entertainment system operable as a system according to embodiments of the present description;

FIG. 2 schematically illustrates a system according to embodiments of the present description; and

FIG. 3 schematically illustrates a method according to embodiments of the present description.

### DETAILED DESCRIPTION

A system for animating a first virtual element within a virtual environment, and a method thereof are disclosed. In the following description, a number of specific details are presented in order to provide a thorough understanding of the embodiments of the present invention. It will be apparent, however, to a person skilled in the art that these specific details need not be employed to practice the present invention. Conversely, specific details known to the person skilled in the art are omitted for the purposes of clarity where appropriate.

In an example embodiment of the present invention, an entertainment system may be operable as a system for animating a first virtual element within a virtual environment.

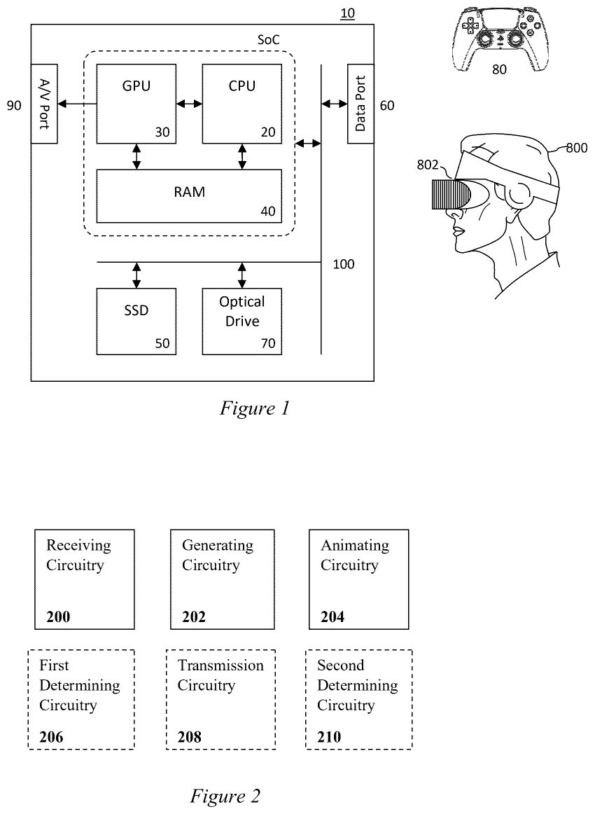

Referring to FIG. 1, an example of an entertainment system 10 is a computer or console.

The entertainment system 10 comprises a central processor 20. This may be a single or multi core processor, for example comprising eight cores. The entertainment system also comprises a graphical processing unit or GPU 30. The GPU can be physically separate to the CPU, or integrated with the CPU as a system on a chip (SoC).

The entertainment device also comprises RAM 40, and may either have separate RAM for each of the CPU and GPU, or shared RAM. The or each RAM can be physically separate, or integrated as part of an SoC. Further storage is provided by a disk 50, either as an external or internal hard drive, or as an external solid state drive, or an internal solid state drive.

The entertainment device may transmit or receive data via one or more data ports 60, such as a USB port, Ethernet® port, WiFi® port, Bluetooth® port or similar, as appropriate. It may also optionally receive data via an optical drive 70.

Interaction with the system is typically provided using one or more handheld controllers 80.

Audio/visual outputs from the entertainment device are typically provided through one or more A/V ports 90, or through one or more of the wired or wireless data ports 60.

Where components are not integrated, they may be connected as appropriate either by a dedicated data link or via a bus 100.

An example of a device for displaying images output by the entertainment system is a head mounted display ‘HMD’ 802, worn by a user 800.

As mentioned previously, a processor having to model the physical interactions of large numbers of virtual elements may be operating at/close to their maximum limit in terms of throughput/bandwidth, which may lead to the gameplay experience being negatively affected (increased input lag, reduced frame rate, reduced resolution, and the like) and/or the processor itself being negatively affected (damaged/degraded due to its own operating temperature increasing above an optimal operating temperature range, for example).

These issues may be mitigated or alleviated by providing at least some of the physical interactions to be modelled by, say, a physics engine being executed by the processor to a machine learning model instead, the machine learning model being trained to generate, based on the kinematic properties (location, velocity, acceleration, and the like) of the virtual element(s) involved in the physical interactions, respective animations to be applied to the virtual element(s).

The resulting animation applied to the virtual element would mimic the results obtained (that is, the physical interactions modelled) by the physics engine while at the same time requiring less computational overhead than the physics engine, thereby reducing the computational burden being placed on the processor. For example, the processor may model more complex interactions (a football rebounding off a goal post, for example) using the more computationally intense processes typically found within physics engines, and may model simpler interactions (a football rolling along a pitch, for example) using the less computationally intense processes typically found within machine learning models to generate animation data.

### System

Accordingly, turning now to FIG. 2, in embodiments of the present description, a system for animating a first virtual element within a virtual environment, comprises: receiving circuitry 200 configured to receive first state data descriptive of a state of the first virtual element, the first state data comprising one or more kinematic properties of the first virtual element; generating circuitry 202 comprising a generating model trained to generate, based on the received first state data, animation data to be applied to the first virtual element; and animating circuitry 204 configured to apply the generated animation data to the first virtual element.

As a non-limiting example of the system in use, consider a user playing a football game on their video game console. At a given time during the football game, an in-game character may be dribbling the football towards the opposing team's goal. In order to model the physical interactions during this dribbling (moments of contact between the character's foot and the football, and the football rolling along the pitch between successive moments of contact, for example), may it be preferable to use a physics engine because the frequency of these interactions may be relatively high (as opposed to the ball merely rolling along the pitch uninterrupted) and because each interaction is likely to be unique (each moment of contact may alter the velocity/acceleration of the football in its own unique way, for example).

After dribbling the football for a certain distance along the pitch, the in-game character may kick the football towards a teammate so as to pass the football to the teammate. Thus, at a different (later) time during the football game, the football is rolling freely (that is, uninterrupted) along the football pitch. In order to model the free rolling of the football, the physics engine may transmit first state data of the football (that is, kinematic properties such as location, velocity, acceleration, and the like) to receiving circuitry 200 in response to a user input signal triggering a pass being received at the video game console.

After receiving the first state data at receiving circuitry 200, the generating model comprised within (that is, being executed by) generating circuitry 202 may generate a rolling animation (that is, animation data) to be applied to the football. Prior to use in the football game, the generating model may have been trained to generate such rolling animations by having had one or more training datasets (real-world footage of a football rolling along a ground/pitch, a virtual football rolling along a virtual pitch, or the like) input thereto, each training dataset being tagged or otherwise associated with a different initial velocity, acceleration, and/or the like.

For example, the generating model may have been trained using a first training dataset comprising real-world image data of a football rolling along a football pitch until it comes to a stop, the first training dataset being tagged with an initial velocity of, say, 40 mph. Moreover, the generating model may have been trained using a second training dataset comprising rendered image data (from the same or a different football game) of a virtual football rolling along a virtual football pitch (such rolling being modelled by the same or a different physics engine), the second training dataset being tagged with an initial velocity of, say, 50 mph, for example. Additionally, the first state data received at receiving circuitry 200 may comprise an initial velocity of, say, 47 mph.

In this case, the generating model, owing to its prior training, may generate a rolling animation depicting a freely rolling football with an initial velocity of 47 mph by interpolating the learnt rolling motions of footballs at 40 mph and 50 mph. After the rolling animation has been generated, animating circuitry 204 may apply the generated animation to the football, and thereby cause the football to roll along the football pitch towards the teammate.

This way, the computational expenditure used to model the free rolling of the football may be reduced, as a machine learning model may be used to generate an animation approximating this relatively simple physical interaction instead of the relatively more complex computations of a physics engine being utilised for such a simple physical interaction.

Once the football has reached the teammate (or even an opponent), the physics engine may resume the modelling of the dribbling of the football by the teammate (or opponent). This resumption of physics engine modelling may be triggered using criteria such as distance between the football and a given in-game character, as a non-limiting example.

### Receiving Circuitry 202

In embodiments of the present description, receiving circuitry 200 is configured to receive first state data descriptive of a state of the first virtual element, the first state data comprising one or more kinematic properties of the first virtual element. In embodiments of the present description, receiving circuitry 200 may comprise one or more data ports (such as data port 60, USB ports, Ethernet® ports, Wi-Fi® ports, Bluetooth® ports, or the like) and/or an I/O bus (such as bus 100, or the like).

A given virtual element may be one of:
i. a virtual object (a football, a goalpost, or the like, for example);
ii. a virtual character (a teammate or opponent in a virtual football game, for example); and
iii. at least a part of the virtual environment itself (a part of the football pitch, for example).

It should be noted that the preceding examples are not exhaustive; persons skilled in the art will appreciate that virtual elements other than those mentioned previously are considered within the scope of the present description.

As will be appreciated by persons skilled in the art, the first state data may be thought of as a description of the first virtual element's motion. As such, the first state data comprises one or more kinematic properties of the first virtual element. A given kinematic property of a given virtual element may be one of:
i. a location of the given virtual element within the virtual environment;
ii. a velocity of the given virtual element;
iii. an acceleration of the given virtual element; and
iv. a jerk of the given virtual element.

It should be noted that the preceding examples are not exhaustive; persons skilled in the art will appreciate that kinematic properties other than those mentioned previously are considered within the scope of the present description.

Turning back to the football game example, receiving circuitry 200 may receive first state data of the football from, say, a physics engine which had been modelling the physical interactions of the football. That is to say that the physics engine may have determined the first state data of the football by performing calculations which model the physical interactions of the football, and has then transmitted such first state data to receiving circuitry (in response to the video games console receiving a user input signal for causing an in-game character to pass the football to a teammate, for example). This first state data may subsequently be used by the generating model to generate a rolling animation for the football, as shall be discussed later herein.

Optionally, in order to enable the generating model to generate animations which depict different types of object behaviour (sliding as well as rolling, for example), it may be advantageous to train the generating model with training datasets depict these different types of object behaviour. For example, the generating model may be trained using datasets depicting boxes sliding along surfaces as well as balls rolling along surfaces. By doing so, the extent to which the physics engine is used to model physical interactions may be reduced yet further, as the generating model may be able to generate more than just one type of object behaviour.

As will be appreciated by persons skilled in the art, in order for the generating model to generate an animation depicting a particular one of the plurality of types of object behaviour it has learnt, the generating model may be provided with an indication as to what type of object the first virtual element is representing. For example, if the generating model is provided with an indication that the first virtual element is a football, then the generating model may generate a rolling animation to be applied to the football, whereas if the generating model is provided with an indication that the first virtual element is a box, then the generating model may generate a sliding animation to be applied to the box.

Hence more generally, receiving circuitry 200 may optionally be configured to receive object metadata indicating a type of object being represented by the first virtual element. This object metadata may subsequently be used by the generating model to generate a rolling animation for the football, as shall be discussed later herein.

Optionally, in order to provide a more physically realistic animation, it may be advantageous to take into account any other virtual elements with which the first virtual element had been interacting prior to receiving circuitry 200 receiving the first state data. For example, an angle of incline in the football pitch may influence the motion of the football as it freely rolls along the football pitch. It may thus be advantageous to take such an angle of incline into account when generating the rolling animation in order that the resulting animation more accurately mimic the results which would have been obtained using the physics engine.

Therefore, receiving circuitry 200 may optionally be configured to receive second state data descriptive of respective states of one or more second virtual elements, the second state data comprising a respective surface geometry of each of the one or more second virtual elements.

As will be appreciated by persons skilled in the art, the second state data may be though of as a description of the one or more second virtual elements' respective geometries/topologies. As such, the second state data comprises a respective surface geometry of each of the one or more second virtual elements. A given surface geometry for a given virtual element may come in the form of a mesh, a point cloud, or the like, for example. This first state data and second state data may subsequently be used by the generating model to generate a rolling animation for the football, as shall be discussed later herein.

As mentioned previously, a processor having to model the physical interactions of large numbers of virtual elements using a physics engine may be operating at/close to their maximum limit in terms of throughput/bandwidth, which may lead to the gameplay experience being negatively affected (increased input lag, reduced frame rate, reduced resolution, and the like). As such, it may be advantageous to utilise these negative effects as a means for triggering the generation of animations by the generating model. That is to say that if, say, the input lag increases above a threshold, the generating model may generate animations mimicking some (if not all) of the physical interactions to be modelled, thereby reducing the number of physical interactions to be modelled using the physics engine, and thus reducing the computational burden placed on the processor.

Therefore, receiving circuitry 200 may optionally be configured to receive one or more performance metrics indicative of a capability with which a physics engine is to model, based on the received first state data and the received second state data where applicable, a subsequent state of the first virtual element. Alternatively put, the performance metrics received at received circuitry 200 provide an indication as to how well the physics engine is handling the calculation of physical interactions within the video game.

As such, the one or more performance metrics may comprise one or more of:
i. a resolution at which the virtual environment is being rendered for display (as mentioned previously, the downstream rendering pipeline may have to reduce the rendering resolution in order to prioritise a more responsive gameplay experience);
ii. a frame rate at which the virtual environment is being rendered for display;
iii. an input lag between receipt of a user input signal and performance of an action within the virtual environment by an in-game avatar in response to the user input signal;
iv. a temperature of processing circuitry configured to execute the physics engine;
v. an amount of electrical power consumed by processing circuitry configured to execute the physics engine (this metric may be thought of as a proxy for processing circuitry temperature in that some of electrical power consumed by the processing circuitry may be converted into heat energy within the processing circuitry);
vi. a processing load of the physics engine; and
vii. an amount of electrical power consumed by a cooling system configured to cool processing circuitry that is configured to execute the physics engine (this metric may be thought of as a proxy for processing circuitry temperature in that higher processing circuitry temperatures may lead to increased amounts of cooling being performed by the cooling system).

It should be noted that the preceding examples are not exhaustive; persons skilled in the art will appreciate that performance metrics other than those mentioned previously are considered within the scope of the present description.

These performance metrics may be, for example, evaluated against respective thresholds the satisfaction of which may subsequently trigger the generation (by the generating model) of animations mimicking some (if not all) of the physical interactions to be modelled, thereby reducing the computational burden placed on the processor, as shall be discussed later herein.

In any case, based on the data received at receiving circuitry 200, the generating model of generating circuitry 202 generates animation data for the first virtual element (the football).

### Generating Circuitry 202

In embodiments of the present description, generating circuitry 202 comprises a generating model trained to generate, based on the received first state data, animation data to be applied to the first virtual element. In embodiments of the present description, the generating model may be any suitable machine learning model/neural network executed by the generating circuitry 202, which may be one or more CPUs 20 and/or one or more GPUs 30, for example. A non-limiting example of animation data generation shall be discussed below.

Typically, in order to model physical interactions between virtual elements using a physics engine, colliders are used. Colliders ensure that “solid” virtual elements do not behave in a physically unrealistic manner (such as by preventing “solid” virtual elements from moving through each other). In general, a collider is an invisible low polygon-count mesh that is associated with the visible skin of a virtual element (the geometry of which is typically defined by a relatively higher polygon-count mesh, a point cloud, or the like). The geometry of the collider for a given virtual element typically approximates that of at least part of the virtual element's skin; for more geometrically complex virtual elements (such as humanoid characters), more than one collider is typically used (one for each of the torso, upper limbs, lower limbs, neck and head, for example), whereas geometrically simpler virtual elements (such as a football) may use one collider (in the shape of a sphere, for example).

In order to generate animation data for the first virtual element, it may be advantageous to manipulate the collider(s) (and thus the skin) of the first virtual element in a similar manner to that found in the commonplace practices of “rigging” and “skinning” virtual elements.

Typically, in video game animation, the virtual element to be animated is usually represented by a “skin” (as mentioned previously), and a hierarchical set of interconnected bones forming the three-dimensional skeleton or “rig” that can be manipulated by an animator so as to animate the skin. The creating and manipulating of the bones of a virtual element is referred to as rigging, whilst the binding of different parts of the corresponding to corresponding bones is called skinning.

In rigging, each bone is associated with a three-dimensional transformation (sometimes referred to herein as a “transform”) that defines at least one of a location (or change thereof), scale (or change thereof) and orientation (or change thereof) of a corresponding bone. The transformations may be defined for successive images frames in the subsequently rendering image data, for each bone, such that the temporal variation in the transformations corresponds to the virtual element performing a particular motion.

In skinning, the bones of the virtual element are each associated with a respective portion of the virtual element's skin. For a skin in the format of a mesh or point cloud, each bone is associated with a group of vertices; for example, in a model of a human being, the “right upper arm” bone would be associated with the vertices making up the polygons in the model's right upper arm.

As will be appreciated by persons skilled in the art, the collider(s) of the first virtual element may therefore be used to rig the first virtual element. As such, the animation data generated by the generating model may be in the form of a series of transforms to be applied to the collider(s) of the first virtual element (a spherical collider of the virtual football, for example), each transform being defined for each of a plurality of successive image frames of the rendered image data (of the football game, for example). For example, the generating model to generate rolling animation data for the football by generating a series of transforms to be successively applied to the football's spherical collider, each transform defining a geometric translation and rotation of the football.

As will be appreciated by persons skilled in the art, the rigging technique discussed may alternatively or additionally be applied directly to the mesh (skin) of the first virtual element. Similarly, where the first virtual element comprises one or more bones, then these bones may be rigged instead/as well (the football virtual element may have one bone comprised within its mesh/skin, for example).

In order for the generating model to learn how to generate series of transforms, one or more training datasets may be input to the generating model prior to use at runtime (during gameplay).

As mentioned previously, the generating model may be trained using one or more sets of image data of one or more real-world objects. A given set of image data may be a sequence of two or more image frames depicting a moving image, and may be tagged with one or more kinematic properties. For each set of image data, the generating model may be trained to correlate a moving object depicted in the set with the kinematic properties associated with the set.

Turning back to the football game example, a given set of image data may depict a football rolling along a football pitch until it comes to a stop, and may be tagged with an initial velocity of, say, 40 mph. This set of image data may be analysed by generating circuitry 206 or different processing circuitry (optionally, of a different computing system) using computer vision in order to identify the football, for example.

The terms “computer vision algorithm” and “object recognition algorithm” refer to any suitable computer-implemented method, software, algorithm, or the like, which causes a computer (such as the apparatus described herein) to recognise/detect objects, animals, humans, or the like from captured images. Such algorithms are well-known in the art, examples of which include Viola-Jones detection methods (optionally based on Haar features), scale-invariant feature transforms (SIFTs), histogram of oriented gradients (HOG) features, and the like. Alternatively or in addition, machine learning and methods, neural networks, artificial intelligence, or the like may be used to recognise/detect objects and the like. Examples of neural network approaches include region based convolutional neural networks (R-CNNs), single shot multi-box detectors (SSDs), you only look once (YOLO) methods, single-shot refinement neural networks for object detection (RefineDets), Retina-Net, deformable convolutional networks, and the like.

Optionally, one or more of the sets of image data may have object metadata respectively associated therewith, wherein the object metadata associated with a given set of image data comprises an indication of one or more objects depicted in the set of image data. Turning back to the football example, if the given set of image data is retrieved from a social media website/application, then the set of image data may have so-called “hashtags” associated therewith, where each hashtag may identify an object in the set of image data (“#football #ball”, for example). These hashtags may aid in the identification of objects in the set of image data, as the hashtag may serve as a priori knowledge of there being a football depicted in the set of image data.

In any case, after the object has been detected in the image frames of the set of image data, the amount of inter-frame motion of the object's features may be determined by tracking said features. Turning back to the football game example, computer vision may be used to track any patterns/designs on the football's surface as it rolls along the pitch, for example.

The resulting inter-frame motion determined from this feature tracking may come in the form of, say, a sequence of changes in position and/or changes in orientation of the detected features between successive image frames of the set of image data, for example. Moreover, the timestamps of the image frames may be included in this sequence, resulting in a time-series dataset describing the changes in the football's position and orientation (that is, the motion of the football) as it rolls along the pitch.

The generating model may learn to correlate this inter-frame motion (that is, the sequence/time-series dataset) with the kinematic properties associated with the inputted set of image data. This learning may enable the generating model to generate, when one or more kinematic properties of that virtual object are input thereto at runtime, a sequence of transforms (that is, inter-frame motion) describing the motion of a virtual object (such as a football), this sequence of transforms being applied to the collider(s) of the virtual object by animation circuitry 204.

Hence more generally, in embodiments where the generating model is trained using one or more sets of image data of one or more real-world objects, each set of the image data may comprise a plurality of image frames and a set of training kinematic properties, and generating circuitry 202 may be configured to analyse each set of image data to identify a real-world object (using computer vision to identify a football in each frame of the set, for example), determine inter-frame motion of the identified real-world object, the inter-frame motion comprising a sequence of changes in position and/or changes in orientation of the identified real-world object between successive image frames of the set of image data, and provide the inter-frame motion and the set of training kinematic properties to the generating model for the generating model to learn a correlation therebetween.

Alternatively or in addition, the generating model may be trained using one or more datasets of one or more virtual elements.

For example, a dataset of one or more rendered images (that is, a set of image data) depicting a virtual football (from the same or a different football game) rolling along a virtual football pitch (such rolling being modelled by the same or a different physics engine) may be input to the generating model, this set of rendered images being tagged with an initial velocity of, say, 50 mph. As will be appreciated by persons skilled in the art, the generating model may be trained in a similar manner to that discussed with respect to using sets of image data of real-world objects.

Alternatively, a time-series dataset describing the motion of a virtual object's collider(s) (as calculated by a physics engine) may be input to the generating model, this time-series dataset/sequence being tagged with one or more kinematic properties. For example, a time-series dataset for the virtual football may describe the changes in position and orientation of the virtual football's collider(s) as the football rolls along the virtual pitch, and may be tagged with an initial velocity of, say, 45 mph. In this case, the generating model may learn to correlate this time-series dataset with the kinematic properties associated with the inputted time-series dataset without having to perform an initial step of detecting the virtual football in the images by using computer vision techniques.

In any case, once trained, the generating model may generate, when one or more kinematic properties of that virtual object are input thereto at runtime, a sequence of transforms (that is, inter-frame motion) describing the motion of a virtual object (such as a football), this sequence of transforms being applied to the collider(s) of the virtual object by animation circuitry 204.

Moreover, at runtime, the generating model may generate a sequence of transforms describing the motion of a virtual object whose first state data (kinematic properties) does not correspond to those used in the training phase. Turning back to the football game example, the input kinematic properties for the virtual football at runtime may be, say, a velocity of 47 mph. In this case, the generating model, owing to its prior training, may generate a rolling animation depicting a freely rolling football with an initial velocity of 47 mph by interpolating between the rolling motion of a virtual football with an initial velocity of 50 mph as learnt from the inter-frame motion obtained from the aforementioned dataset of rendered images of the virtual football and the rolling motion of a virtual football with an initial velocity of 45 mph as learnt from the aforementioned time-series dataset describing the motion of the virtual football's collider(s) (as calculated by a physics engine), for example.

Optionally, the generating model is trained to generate the animation data by: generating a latent space based on training data input thereto; and selecting, based on the received first state data, one or more latent variables from the generated latent space, each latent variable being associated with a kinematic property of the virtual element.

As will be appreciated by persons skilled in the art, a latent space is an embedding of items (sets of image data, for example) within a manifold in which items with greater resemblance to each other are positioned closer together than those with less resemblance. A given position within this latent space may be defined by a set of coordinates typically known as latent variables. Each coordinate/latent variable is typically associated with a parameter/characteristic of the items embedded therein (which may be kinematic properties such as velocity, acceleration, and the like, for example).

Types of machine learning models that are capable of generating latent spaces include Word2Vec, GloVe, Siamese Networks, Variational Autoencoders, and the like.

As an example of the latent space being generated, tagged sets of real-world image data and/or datasets of virtual elements (that is, training data) may be input to the generating model, the tags comprising information regarding the kinematic properties of moving objects within the sets/datasets. The sets/datasets may relate to the rolling motion of (virtual) footballs or other spherical objects. The generating model may generate a latent space in which the inter-frame motions/time-series datasets describing the (virtual) footballs' motions (extracted from the tagged sets/datasets) are embedded according to their associated (tagged) kinematic properties. During gameplay of a virtual football game, the first state data (kinematic properties) of the virtual football may be input to the generating model, and this generating model may select latent variables which correspond to the first state data in order to obtain a series of transforms which describes the rolling motion of a virtual football having the kinematic properties describes in the first state data.

It should be noted that the selected latent variables do not necessarily have to coincide with those of an item (tagged set/dataset) having been embedded within the latent space. Rather, where the selection of latent variables does not coincide so, the data obtained from the latent space may be an interpolation of the items embedded within the latent space.

As will be appreciated by persons skilled in the art, the motion of a given virtual element may be influenced by the type of object the given virtual element represents. For example, a ball virtual element representing a ball is likely to roll along a virtual surface, whereas a virtual element representing a box is likely to slide along the virtual surface.

Hence, in embodiments where receiving circuitry 200 is configured to receive object metadata indicating a type of object being represented by the first virtual element, the generating model may be trained to generate at least part of the animation data based on the object metadata.

In order for the generating model to learn how to distinguish between different types of object motion/behaviour (sliding, rolling, and the like), the training data used to train the generating model may also be associated with object metadata. For example, a first set of image data of a real-world football rolling along a pitch may be associated with object metadata comprising information such as “ball”, “football”, “sphere”, and the like, and a second set of image data of a real-world box sliding along a warehouse floor may be associated with object metadata comprising information such as “box”, “crate”, “cuboid”, and the like. The first and second sets of image data may be input into the generating model in order that the generating model may learn to correlate the inter-frame motions obtained from these sets of image data with the respective object depicted in these sets of image data; a rolling ball is likely to exhibit both translational and rotational motion between successive image frames of the first set of image data, whereas a sliding box is likely to exhibit translational motion between image frames of the second set of image data.

Thus, once trained in this way, the generating model may generate, when a virtual element's first state data and object metadata, a sequence of transforms (that is, inter-frame motion) which describes a given type of motion for the given type of object being represent by that virtual element. For example, if the generating model is provided with an indication that the virtual element is a football, then the generating model may generate a rolling animation to be applied to the football, whereas if the generating model is provided with an indication that the virtual element is a box, then the generating model may generate a sliding animation to be applied to the box.

As mentioned previously, this consideration of the type of object being represented by the virtual element may be advantageous in that the extent to which the physics engine is used to model physical interactions may be reduced yet further, as the generating model may be able to generate more than just one type of object motion/behaviour.

As will be appreciated by persons skilled in the art, the motion of a first virtual element (such as the rolling of a virtual football) may be influenced by the geometry of any other (second) virtual elements (such as a virtual football pitch) with which the first virtual element is interacting. For example, an angle of incline in the football pitch may influence the motion of the football as it freely rolls along the football pitch.

Hence, in embodiments where receiving circuitry 200 is configured to receive second state data descriptive of respective states of one or more second virtual elements, the second state data comprising a respective surface geometry of each of the one or more second virtual elements, the generating model may be trained to generate, based on the received first state data and the received second state data, the animation data to be applied to the first virtual element.

As mentioned previously, the second state data may be thought of as a description of the one or more second virtual elements' respective geometries/topologies. As such, the second state data comprises a respective surface geometry of each of the one or more second virtual elements. A given surface geometry for a given virtual element may come in the form of a mesh, one or more colliders, a point cloud, or the like, for example.

In order to generate animation data that takes into account the geometry of second virtual elements with which the first virtual elements is interacting, the training data used to train the generating model may be associated with second state data defining the surface geometry of the second virtual elements. For example, image data of a real-world football rolling along a pitch may be associated with geometry data defining the surface geometry of the pitch. This second state data may be derived from the image data itself, or may come in the form of pre-defined metadata. Regarding the former, the image data may have been captured with a depth camera, and so generating circuitry 202 may be configured to obtain the second state data of the second virtual elements (the pitch) by finding the pixel location (x, y coordinates) and depth values (z coordinate) associated with features on the pitch (lines/markings, for example) detected using computer vision algorithm, for example. Regarding the latter, the second state data may come in the format of a mesh, point cloud, or the like, which defines the surface geometry of the pitch, as mentioned previously. As will be appreciated by persons skilled in the art, the above methods may apply, mutatis mutandis, to the case where datasets of virtual elements (rendered image data or time-series datasets) are used as training data.

The training dataset (including the second state data) may be input to the generating model in order that the generating model may learn to correlate the inter-frame motions of the first virtual element and the geometry of the second virtual elements with which the first virtual element is interacting.

Thus, once trained in this way, the generating model may generate, when first state data and second state data are input thereto at runtime, a sequence of transforms (that is, inter-frame motion) which describes the motion of a first virtual element when interacting with a second virtual element (a football rolling along an uneven football pitch terrain).

As will be appreciated by persons skilled in the art, the runtime geometry of the football pitch may be different to the geometry of the pitches used to train the generating model. In order to generate animation data that more accurately describes the motion of the football as it rolls along this pitch, the generating model may select two or more training geometries that resemble the runtime geometry of the pitch, and interpolate, based on the difference between the runtime geometry and the training geometries, between the sequences of transforms/inter-frame motions associated with these training geometries to determine a runtime sequence of transforms for the football.

In any case, it would be advantageous to standardise the format of the second state data comprised within the training data or the runtime input data because the format of the second state data associated with each geometry is likely to vary with each set. For example, the resolution of the meshes/point clouds used to represent the surface geometry of the second virtual elements may differ for each geometry. Without format standardisation, the time taken to train the generating model and/or generated animation data therewith may increase; higher resolution geometry data typically comprises a larger amount of bits/bytes, and machine learning models typically learn/generate outputs at a slower rate when larger amounts of data are input thereto. Hence more generally, generating circuitry 202 may be configured to convert the format of the second state data (during training and/or during runtime operation) into a standardised format prior to input to the generating model. Examples of such standardised formats include non-uniform rational B-spline (NURBS) surfaces and/or curves, Bezier curves, and the like.

As will be appreciated by persons skilled in the art, some motions may not be accurately modelled at runtime by using a generating model to generate animation data describing said motions. This situation may arise where the generating model has not been trained using training data whose kinematic properties (first state data) and optionally second virtual element geometries (second state data) which is similar that of the runtime kinematic properties and optionally second virtual elements geometries, “similar” here meaning that the difference between the first state data (and optionally second state data) at runtime and the first state data (and optionally second state data) in at least one training dataset is within a threshold amount.

Hence, embodiments of the present description may comprise first determining circuitry 206, which may be configured to determine, based on the received first state data and the received second state data where applicable, whether the animation data is to be generated. In embodiments of the present description, first determining circuitry 206 may be one or more CPUs 20 and/or one or more GPUs 30, for example.

For example, first determining circuitry 206 may be configured to determine whether any of the training datasets comprise first state data (and optionally second state data) which is within a threshold difference from the first state data (and optionally second state data) received at runtime. If such a training dataset is found, then this implies that the generating model is likely to accurately generate animation data based on the runtime first (and second) state data, as the generating model has been previously trained with similar first (and second) state data. In this case, first determining circuitry 206 may transmit the received (runtime) first (and second) state data to generating circuitry 202 in order for the generating model to generate the animation data.

In the case where no training dataset comprising first (and second) state data similar to that at runtime is found, then first determining circuitry 206 may prevent transmission of the runtime first (and second) state data to generating circuitry 202, and instead transmit a trigger signal to the physics engine in order for the physics engine to model the subsequent motion of the first virtual element.

Another situation in which the generating model may not accurately model the motions of the first virtual element may be that of more complex interactions such as collisions. For example, the generating model may not generate animation data for the football which accurately depicts the football rebounding off a goalpost because this motion is highly dependent upon the geometry of the football and goalposts, as well as the point of contact therebetween.

Therefore, first determining circuitry 206 may be configured to determine, based on the received first state data and the received second state data, whether the animation data is to be generated by determining whether a second virtual element is within a threshold distance from the first virtual element. In the case where the second virtual element (a goalpost) is outside of the threshold distance from the first virtual element (the football) for a given moment in the gameplay, first determining circuitry 206 may transmit the received (runtime) first (and second) state data to generating circuitry 202 in order for the generating model to generate the animation data, as it has been determined that a collision may not arise between the football and goalpost.

After the generating model generates the animation data for the football, animating circuitry 204 applies this animation data to the football, thereby making it roll along the ground. During this application of the animation data, it may be found in a subsequent moment in gameplay that the goalpost now lies within a threshold distance of the football. As will be appreciated by persons skilled in the art, the first state data received at receiving circuitry 200 during/at this subsequent moment may come from animating circuitry 204, as the animation data being applied may comprise a time-series sequence of transforms/inter-frame motion describing the motion (and thus, kinematic properties) of the football. The second state data received at receiving circuitry 200 during/at this subsequent moment may be same as that received earlier at the given moment in gameplay; the goalpost is not likely to have changed shape.

In this case, it has been determined that a collision may arise between the football and goalpost, and so the motion of the football should instead be modelled by the physics engine instead of the generating model. As such, embodiments of the present description may comprise transmission circuitry 208, which may be configured to transmit the received first state data and the received second state data where applicable to a physics engine for modelling a subsequent state of the first virtual element if the first determining circuitry determines that the animation data is not to be generated. In embodiments of the present description, transmission circuitry 208 may be one or more CPUs 20 and/or one or more GPUs 30, for example.

That is to say that transmission circuitry 208 may transmit the first state data received from animating circuitry 204 in the event that there has been a break in the usage of a physics engine to model the first virtual element's motion (the physics engine is not likely to have the most up-to-date first state data in this case, but rather animating circuitry 204).

As will be appreciated by persons skilled in the art, the use of a threshold distance between the first virtual element and second virtual elements to determine whether a collision will arise may lead to a situation where the physics engine is only ever used to model the first virtual element's motion. For example, first determining circuitry 206 may find that the football pitch is within a threshold distance of the football due the contact therebetween arising from the rolling motion of the football, and so transmission circuitry 208 may transmit the first and second state data to the physics engine for modelling the football's rolling motion (which would otherwise be a motion suitable for being modelled by the generating model and animating circuitry 204).

Therefore, it may be beneficial to further consider the nature of the interaction between first and second virtual elements (as well as consider the distance therebetween) so that simpler interactions (such as rolling) may be modelled via animation data generation, and more complex interactions may be modelled by the physics engine. To achieve this, it may be advantageous to consider the angle between a motion vector of the first virtual element and the surface normal of a nearest point on the second virtual element, the nearest point being that which is nearest to the first virtual element.

In the case of a football rolling along a pitch (a simpler interaction), a motion vector (velocity, acceleration, jerk) of the football (obtained from the first state data) may be at, say, 90 degrees to the surface normal to the point on the pitch which is in contact with the football (that is, the nearest point of the pitch), whereas in the case of a football about to collide with a goalpost (a more complex interaction), the motion vector of the football may be at, say, 170 degrees to the surface normal to the point on the goalpost which nearest to the football.

Thus, in order to distinguish between rolling and collision, a threshold angle may also be imposed by first determining circuitry 206 when determining if a second virtual element is within a threshold distance of the first virtual element. For example, first determining circuitry 206 may be configured to determine whether the animation data is to be generated in the case where no second virtual elements are within the threshold distance of the first virtual element (as is the case during projectile motion) or in the case where, if a second virtual element is found to be within the threshold distance, the angle between the first virtual element's motion vector and the surface normal of the nearest point of the second virtual element is less than or equal to a threshold amount (say, 90 degrees in the case of rolling motion, for example).

Conversely, if a second virtual element is found to be within the threshold distance of this first virtual element, and the angle formed between the first virtual element's motion vector and the surface normal of the nearest point on the second virtual element is greater than a threshold amount, then first determining circuitry 206 may determine that a collision may arise, and so transmission circuitry 208 may transmit the first and second state data to the physics engine for modelling the football's collision with the goalpost.

As will be appreciated by persons skilled in the art, once the collision is modelled by the physics engine, the modelling of the subsequent rolling of the football may be performed by the generating model and animating circuitry 204 once the goalpost is no longer within the threshold distance from the football and/or the angle between the football's motion vector and the surface normal of the goalpost's nearest point no longer exceeds the threshold angle.

As mentioned previously, a processor having to model the physical interactions of large numbers of virtual elements using a physics engine may be operating at/close to their maximum limit in terms of throughput/bandwidth, which may lead to the gameplay experience being negatively affected (increased input lag, reduced frame rate, reduced resolution, and the like). As such, it may be advantageous to utilise these negative effects as a means for triggering the generation of animations by the generating model. That is to say that if, say, the input lag increases above a threshold, the generating model may generate animations mimicking some (if not all) of the physical interactions to be modelled, thereby reducing the number of physical interactions to be modelled using the physics engine, and thus reducing the computational burden placed on the processor.

Therefore, in embodiments where receiving circuitry 200 is configured to receive one or more performance metrics indicative of a capability with which a physics engine is to model, based on the received first state data and the received second state data where applicable, a subsequent state of the first virtual element, the system may comprise second determining circuitry 210, which may be configured to determine, based on one or more of the received performance metrics, whether the subsequent state of the first virtual element is to be modelled by the physics engine. In embodiments of the present description, second determining circuitry 210 may be one or more CPUs 20 and/or one or more GPUs 30, for example. In these embodiments, the generating model may be trained to generate the animation data to be applied to the first virtual element if the second determining circuitry determines that the subsequent state of the first virtual element is not to be modelled by the physics engine.

This is all to say that in the event the physics engine (or the processor executing it) is overburdened in a particular moment of gameplay (as may be determined by evaluating the aforementioned performance metrics against respective threshold values to find that such threshold values are exceeded), a failover may be provided in which some/a subset of motions/physical interactions to be modelled in that moment of gameplay are handed over to the generating model, the generating model generating animation data to be applied to the appropriate virtual elements such that this subset of motions/physical interactions may be rendered for display during the given moment of gameplay, thereby alleviating the computational burden placed on the physics engine (or the processor executing it).

In the case that second determining circuitry 210 determines that the (or the processor executing it) is not overburdened in a particular moment of gameplay (as may be determined by evaluating the aforementioned performance metrics against respective threshold values to find that such threshold values are not exceeded), then second determining circuitry 210 (or even transmission circuitry 208, where applicable) may be configured to transmit the received first state data and the received second state data where applicable to a physics engine for modelling a subsequent state of the first virtual element if the first determining circuitry determines that the animation data is not to be generated.

In any case, the generating model generates animation data which is to be applied to (the colliders of) the virtual elements, and animating circuitry 204 applies said animation data to (the colliders of) the virtual elements, thereby animating the virtual elements.

### Animating Circuitry 204

In embodiments of the present description, animating circuitry 204 is configured to apply the generated animation data to the first virtual element. In embodiments of the present description, animating circuitry 204 may be one or more CPUs 20 and/or one or more GPUs 30, for example.

As discussed previously, the generated animation data may be in the form of a series of transforms to be applied to the first virtual element's collider(s). Thus, in order to depict the first virtual element as being in motion (a rolling football, for example) over the course of a plurality of successive image frames, applying circuitry 204 may apply successive ones of the transforms to the first virtual element's collider(s) such that for a given image frame to be rendered, the first virtual element's collider(s) (and thus the first virtual element's skin) has a different location and/or orientation within the virtual environment with respect to a previously rendered image frame.

Hence, it will be appreciated that embodiments of the present description may comprise rendering circuitry configured to render, for display, at least part of the first virtual element having the animation data applied thereto.

In any case, embodiments of the present description seek to reduce the computational burden placed on a processor modelling the physical interactions of virtual elements by providing at least some (if not all) of the physical interactions to be modelled by, say, a physics engine being executed by the processor to a machine learning model instead, the machine learning model being trained to generate, based on the kinematic properties (location, velocity, acceleration, and the like) of the virtual element(s) involved in the physical interactions, respective animations to be applied to the virtual element(s); the resulting animation applied to the virtual element would mimic the results obtained (that is, the physical interactions modelled) by the physics engine while at the same time requiring less computational overhead than the physics engine.

### Method

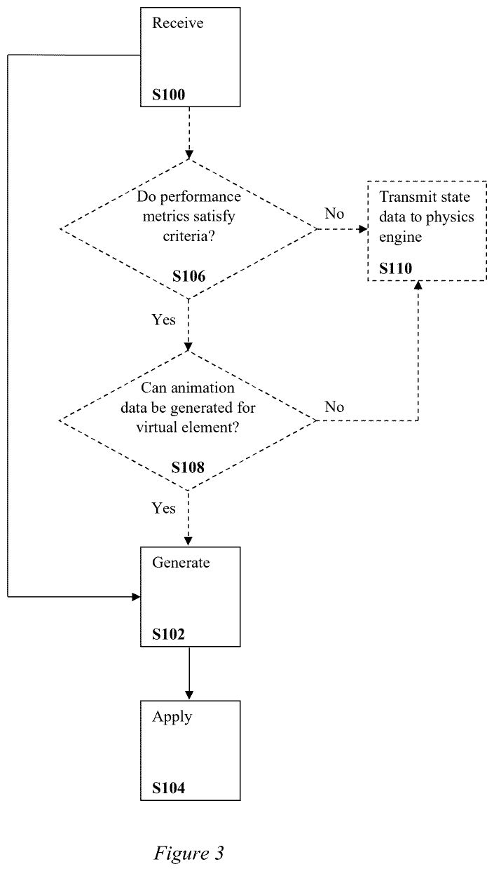

Turning now to FIG. 3, a method of animating a first virtual element within a virtual environment comprises the following steps.
S100: receiving first state data descriptive of a state of the first virtual element, the first state data comprising one or more kinematic properties of the first virtual element, as described elsewhere herein.
S102: generating, using a trained generating model, animation data to be applied to the first virtual element based on the received first state data, as described elsewhere herein.
S104: applying the generated animation data to the first virtual element, as described elsewhere herein.

It will be apparent to a person skilled in the art that variations in the above method corresponding to operation of the various embodiments of the apparatus as described and claimed herein are considered within the scope of the present invention.

It will be appreciated that the above methods may be carried out on conventional hardware (such as entertainment device 10) suitably adapted as applicable by software instruction or by the inclusion or substitution of dedicated hardware.

Thus the required adaptation to existing parts of a conventional equivalent device may be implemented in the form of a computer program product comprising processor implementable instructions stored on a non-transitory machine-readable medium such as a floppy disk, optical disk, hard disk, solid state disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

The foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

Embodiments of the present disclosure may be implemented in accordance with any one or more of the following numbered clauses:
1. A system for animating a first virtual element within a virtual environment, comprising:
   receiving circuitry configured to receive first state data descriptive of a state of the first virtual element, the first state data comprising one or more kinematic properties of the first virtual element;
   generating circuitry comprising a generating model trained to generate, based on the received first state data, animation data to be applied to the first virtual element; and
   animating circuitry configured to apply the generated animation data to the first virtual element.
2. A system according to clause 1, wherein:
   the receiving circuitry is configured to receive second state data descriptive of respective states of one or more second virtual elements, the second state data comprising a respective surface geometry of each of the one or more second virtual elements; and
   the generating model is trained to generate, based on the received first state data and the received second state data, the animation data to be applied to the first virtual element.
3. A system according to clause 1 or clause 2, comprising first determining circuitry configured to determine, based on the received first state data and the received second state data where applicable, whether the animation data is to be generated.
4. A system according to clause 3, comprising transmission circuitry configured to transmit the received first state data and the received second state data where applicable to a physics engine for modelling a subsequent state of the first virtual element if the first determining circuitry determines that the animation data is not to be generated.
5. A system according to any preceding clause, wherein:
   the receiving circuitry is configured to receive one or more performance metrics indicative of a capability with which a physics engine is to model, based on the received first state data and the received second state data where applicable, a subsequent state of the first virtual element;
   the system comprises second determining circuitry configured to determine, based on one or more of the received performance metrics, whether the subsequent state of the first virtual element is to be modelled by the physics engine; and
   the generating model is trained to generate the animation data to be applied to the first virtual element if the second determining circuitry determines that the subsequent state of the first virtual element is not to be modelled by the physics engine.
6. A system according to clause 5, wherein the one or more performance metrics comprises one or more of:
   i. a resolution at which the virtual environment is being rendered for display;
   ii. a frame rate at which the virtual environment is being rendered for display;
   iii. an input lag between receipt of a user input signal and performance of an action within the virtual environment by an in-game avatar in response to the user input signal;
   iv. a temperature of processing circuitry configured to execute the physics engine;
   v. an amount of electrical power consumed by processing circuitry configured to execute the physics engine;
   vi. a processing load of the physics engine; and
   vii. an amount of electrical power consumed by a cooling system configured to cool processing circuitry that is configured to execute the physics engine.
7. A system according to any preceding clause, wherein:
   the receiving circuitry is configured to receive object metadata indicating a type of object being represented by the first virtual element; and
   the generating model is trained to generate at least part of the animation data based on the object metadata.
8. A system according to any preceding clause, wherein the generating model is trained using one or more sets of image data of one or more real-world objects.
9. A system according to clause 8, wherein:
   each set of image data comprises a plurality of image frames and a set of training kinematic properties; and
   the generating circuitry is configured to:
      analyse each set of image data to identify a real-world object,
      determine inter-frame motion of the identified real-world object, the inter-frame motion comprising a sequence of changes in position and/or changes in orientation of the identified real-world object between successive image frames of the set of image data, and
      provide the inter-frame motion and the set of training kinematic properties to the generating model for the generating model to learn a correlation therebetween.
10. A system according to any preceding clause, wherein the generating model is trained using one or more datasets of one or more virtual elements.
11. A system according to any preceding clause, wherein the generating model is trained to generate the animation data by:
   generating a latent space based on training data input thereto; and
   selecting, based on the received first state data, one or more latent variables from the generated latent space, each latent variable being associated with a kinematic property of the virtual element.
12. A system according to any preceding clause, wherein a given virtual element is one of:
   i. a virtual object;
   ii. a virtual character; and
   iii. at least a part of the virtual environment itself.
13. A method of animating a first virtual element within a virtual environment, comprising the steps of:
   receiving first state data descriptive of a state of the first virtual element, the first state data comprising one or more kinematic properties of the first virtual element;
   generating, using a trained generating model, animation data to be applied to the first virtual element based on the received first state data; and
   applying the generated animation data to the first virtual element.
14. A computer program comprising computer executable instructions adapted to cause a computer system to perform the method of clause 13.
15. A non-transitory, computer-readable storage medium having stored thereon the computer program of clause 14.

1. A system for animating a first virtual element within a virtual environment, comprising:
receiving circuitry configured to receive first state data descriptive of a state of the first virtual element, the first state data comprising one or more kinematic properties of the first virtual element;
generating circuitry comprising a generating model trained to generate, based on the received first state data, animation data to be applied to the first virtual element; and
animating circuitry configured to apply the generated animation data to the first virtual element.

2. The system of claim 1, wherein:
the receiving circuitry is configured to receive second state data descriptive of respective states of one or more second virtual elements, the second state data comprising a respective surface geometry of each of the one or more second virtual elements; and
the generating model is trained to generate, based on the received first state data and the received second state data, the animation data to be applied to the first virtual element.

3. The system of claim 1, comprising first determining circuitry configured to determine, based on the received first state data and the received second state data where applicable, whether the animation data is to be generated.

4. The system of claim 3, comprising transmission circuitry configured to transmit the received first state data and the received second state data where applicable to a physics engine for modelling a subsequent state of the first virtual element if the first determining circuitry determines that the animation data is not to be generated.

5. The system of claim 1, wherein:
the receiving circuitry is configured to receive one or more performance metrics indicative of a capability with which a physics engine is to model, based on the received first state data and the received second state data where applicable, a subsequent state of the first virtual element;
the system comprises second determining circuitry configured to determine, based on one or more of the received performance metrics, whether the subsequent state of the first virtual element is to be modelled by the physics engine; and
the generating model is trained to generate the animation data to be applied to the first virtual element if the second determining circuitry determines that the subsequent state of the first virtual element is not to be modelled by the physics engine.

6. The system of claim 5, wherein the one or more performance metrics comprises one or more of:
i. a resolution at which the virtual environment is being rendered for display;
ii. a frame rate at which the virtual environment is being rendered for display;
iii. an input lag between receipt of a user input signal and performance of an action within the virtual environment by an in-game avatar in response to the user input signal;
iv. a temperature of processing circuitry configured to execute the physics engine;
v. an amount of electrical power consumed by processing circuitry configured to execute the physics engine;
vi. a processing load of the physics engine; and
vii. an amount of electrical power consumed by a cooling system configured to cool processing circuitry that is configured to execute the physics engine.

7. The system of claim 1, wherein:
the receiving circuitry is configured to receive object metadata indicating a type of object being represented by the first virtual element; and
the generating model is trained to generate at least part of the animation data based on the object metadata.

8. The system of claim 1, wherein the generating model is trained using one or more sets of image data of one or more real-world objects.

9. The system of claim 8, wherein:
each set of image data comprises a plurality of image frames and a set of training kinematic properties; and
the generating circuitry is configured to:
analyse each set of image data to identify a real-world object,
determine inter-frame motion of the identified real-world object, the inter-frame motion comprising a sequence of changes in position and/or changes in orientation of the identified real-world object between successive image frames of the set of image data, and
provide the inter-frame motion and the set of training kinematic properties to the generating model for the generating model to learn a correlation therebetween.

10. The system of claim 1, wherein the generating model is trained using one or more datasets of one or more virtual elements.

11. The system of claim 1, wherein the generating model is trained to generate the animation data by:
generating a latent space based on training data input thereto; and
selecting, based on the received first state data, one or more latent variables from the generated latent space, each latent variable being associated with a kinematic property of the virtual element.

12. The system of claim 1, wherein a given virtual element is one of:
i. a virtual object;
ii. a virtual character; and
iii. at least a part of the virtual environment itself.

13. A method of animating a first virtual element within a virtual environment, comprising the steps of:
receiving first state data descriptive of a state of the first virtual element, the first state data comprising one or more kinematic properties of the first virtual element;
generating, using a trained generating model, animation data to be applied to the first virtual element based on the received first state data; and
applying the generated animation data to the first virtual element.

14. A non-transitory machine-readable storage medium which stores computer software which, when executed by a computer, causes the computer to perform a method for animating a first virtual element within a virtual environment, comprising the steps of:
receiving first state data descriptive of a state of the first virtual element, the first state data comprising one or more kinematic properties of the first virtual element;
generating, using a trained generating model, animation data to be applied to the first virtual element based on the received first state data; and
applying the generated animation data to the first virtual element.
